(19) United States
(12) Patent Application Publication
(10) Pub. No.: US 2003/0084108 A1
(43) Pub. Date: May 1, 2003

(54) System and method for providing a push gateway between consumer devices and remote content povider centers

(76) Inventor: Majid Syed, Princeton, NJ (US)

Correspondence Address: Blaney Harper, Jones, Day, Reavis & Pogue, 51 Louisiana Ave., NW, Washington, DC, 20001, US

(21) Appl. No.: 10/007,338

(22) Filed: Oct. 26, 2001

(51) Int. Cl. G06F 15/16

(52) U.S. Cl. 709/206

(57) ABSTRACT

An efficient Push-Pull data gateway is described for use by remote content provider centers or content sponsors to Push data content or have it pulled from remote networks. The data content is then broadcast through an existing in-band on-channel (IBOC) network to consumer devices equipped with iBOC receiver. Examples of data content include digital audio and data broadcasts and examples of consumer devices include consumer electronics device for receiving such broadcasts. The gateway particularly serves as a data concentration and management center with several data processing features for facilitation of data transmission. The described protocol utilized by the Push-Pull gateway supports handling of transmissions errors, various addressing schemes, multiple transmission speeds, prioritization of content, and other scheduling features.

### FIELD OF INVENTION

The present invention relates generally to the field of network-based data transmission. More specifically, the present invention is related to data transmission, via a Push/Pull gateway to remote devices linked via a network such as an IBOC network.

### BACKGROUND OF THE INVENTION

Definitions have been provided to help with a general understanding of network transmissions and are not meant to limit their interpretation or use thereof. Thus, one skilled in the art may substitute other known definitions or equivalents without departing from the scope of the present invention.

Datagram: A portion of a message transmitted over a packet-switching network. One key feature of a packet is that it contains the destination address in addition to the data. In IP networks, packets are often called datagrams.

Push: Push refers to sending data to a client. The World Wide Web (WWW) is based on a Pull technology where the client must request a Web page before it is sent (pushed). Broadcast media, on the other hand, utilize Push technologies because information is sent out (pushed) regardless of whether anyone is tuned in.

Increasingly, companies are using the Internet to deliver information Push-style. The most widely used Push technology is e-mail. This is a Push technology because one receives mail whether they ask for it or not; that is, the sender pushes the message to the receiver.

Pull: Pull refers to requesting data from another program or computer. The opposite of Pull is Push, where data is sent without a request being made. The terms Push and Pull are used frequently to describe data sent over the Internet. As mentioned earlier, the WWW is based on Pull technologies, where a page isn't delivered until a client requests it. Increasingly, however, information services are harnessing the Internet to broadcast information using Push technologies. A prime example is the PointCast Network™.

Radio Broadcasting: Radio broadcasting refers to the airborne transmission of audio signals via electromagnetic carrier waves accessible by a wide population by means of standard receivers, such as radios. Radio waves are not only deployed as a carrier in standard radio broadcasting, but also in wireless telegraphy, telephone transmission, television, navigation systems, and radar. Radio waves are of different length and usually identified by their frequency, i.e., the number of times per second that a periodic wave repeats. The shortest waves have the highest frequency, and the longest waves have the lowest frequency. A typical radio communication system features the following two main components: a transmitter and a receiver. The transmitter generates electrical oscillations at a radio frequency called the carrier frequency. In analog radio broadcasting, either the amplitude (AM) or the frequency (FM) itself may be modulated to vary the carrier wave, thereby producing sounds. At the receiver device, the antenna converts the incoming electromagnetic waves into electrical oscillations, which are then increased in intensity by amplifiers. Finally, a speaker in the receiving device converts the electrical impulses into sound waves audible to the human ear. Several types of noise such as static—caused by electrical disturbances in the atmosphere, hum—a steady low-frequency note commonly produced by the frequency of the alternating-current power supply, hiss—a steady high frequency note, or a whistle—a pure high-frequency note produced by unintentional audio-frequency oscillation, cause broadcast interference and distortion at the receiver end.

Currently, approximately 10,000 radio stations are located throughout the U.S.A., reaching a vast audience. U.S. radio stations are operating with analog technology and are almost evenly divided between two broadcast spectrums: amplitude modulation (AM) at 0.525-1.705 MHz and frequency modulation (FM) at 88-108 MHz. A new emerging technology known as in-band on-channel (IBOC) allows these radio stations to deploy digital transmission technology within existing bandwidths allocated to the AM and FM stations. Digital transmission allows data processing in strings of 0's and 1's, rather than analog transmission by means of electronic signals of varying frequency or amplitude that are added to carrier wave of a given frequency. Digital technology is primarily deployed in new communication media, such as computers and fiber-optic networks. By way of example, a modem is used to: modulate outgoing digital signals from a computer to analog signals for a conventional copper twisted pair telephone line, demodulate the incoming analog signal, and convert it to a digital signal for the computer in order to facilitate communication via the Internet.

The Internet is an international system of computer networks, comprised of a series of computers interconnected by means of data lines, routers, and/or wireless communication links. Each computer, as a part of the Internet, serves amongst other things, as a storage device for data flowing between computers. The Internet facilitates data interchange, as well as remote login, electronic mail, and newsgroups. One integral part of the Internet is the World Wide Web (hereafter “the Web” or WWW), a computer-based network of information resources. The Internet is also a transmission medium for emails, short messages (SMS) or other data content.

Like traditional computer networks, the Internet operates within the client-server format. Servers are typically remote computer systems that store and transmit electronic documents over the network to other computers upon request. Clients, on the other hand, are computer systems or other interactive devices that request/receive the stored information from a server. A client may be a personal computer or a wireless device such as a handheld, a cellular phone or other Internet-enabled consumer device that may be capable of two-way communication.

In the traditional client-server model, a client requests a service or data from a server, which then responds by transmitting the data to the client. As mentioned earlier, this is known as “Pull” technology because the client “pulls” data from the server. The Web is a typical example of Pull technology, wherein a user sends a data request by entering a Uniform Resource Locator (URL) to a server, which then answers by sending the Web site at the requested URL back to the user. In contrast, “Push” technology, which also operates within the client-server model, does not require a user initiated data request prior to the transmission of data. Such data transmissions are common in the so-called Web Casting technology, i.e., the prearranged updating of news, weather, or other selected information on the interface of a device with digital capabilities through periodic and generally unobtrusive transmission. Currently, Web Casting technology primarily targets computer users. Yet, as described above, there is a huge audience in the radio broadcast area, and there exists a strong demand for data casting content such as: song titles, artist names, lyrics, traffic and weather news, stock market quotes, pager messages, or complementary product information. New radio receivers with Liquid Crystal Displays (LCD) combined with the deployment of the in-band on-channel (IBOC) technology facilitate such data casting.

All data transmitted over the Internet is broken down into small units of data called packets. Each packet is assigned a unique number, which is later used to re-assemble the data packets when they arrive at their destination. For this reason, the Internet is also called a packet-switched network. The series of protocols used to achieve packet-switching is Transmission Control Protocol/Internet Protocol (TCP/IP). In order to standardize the communication between servers and clients on the Internet, additional protocols that are usually packaged with TCP/IP are used for the transmission of data.

As known in the art, network communication is based on the seven layer model Open System Interconnection (OSI). Information being transferred from a software application in one communication system to another, e.g., from one computer to another via the Internet, must pass through each of the OSI layers. Each layer has a different task in the information exchange process and the actual information exchange occurs between peer OSI layers. Each layer in the source system adds control information to the transmission data and each layer in the destination system analyzes and removes the control information from that data. At the lowest layer, the physical layer, the entire information packet is placed onto the network medium where it is picked up by the receiving unit. In this model, protocols represent and describe the formal rules and conventions that govern the exchange of information over a network medium. The protocol likewise implements the functions of one or more of the OSI layers. The transport protocol for Web sites is the Hyper Text Transfer Protocol (HTTP), for e-mails the transport protocol is the Simple Mail Transfer Protocol (SMTP) and for software programs the transfer protocol is the File Transfer Protocol (FTP). It should be noted that these protocols vary in their specifications and, furthermore, many additional protocols exist to assist in standardizing communication standards.

Web sites are formatted in Hyper Text Markup Language (HTML), Wireless Markup Language (WML), or Extensible Markup Language (XML). These are standard text formatting languages for interconnected networks such as the Internet. So-called Web browsing software interprets HTML, WML, and/or XML documents, thereby allowing users to view Web sites on their display screen. As in the case with protocols, additional languages exist for the marking-up of Web sites or other data.

The data link between the Internet and a wireless device is established via a wireless modem or an antenna and a wireless carrier service using radio frequencies, rather than via twisted-pair or fiber-optic cables. Content for wireless services is marked up in say Wireless Application Protocol (WAP), rather than HTTP. For that reason, Internet servers cannot directly communicate with, and content cannot be directly sent to, wireless devices. Another problem to be confronted in wireless devices is the noise interference of data transmission via radio waves. Data casters are unable to control whether the transmission of the submitted data is compromised or corrupt when received by the consumer device. Therefore, a system and method for improved data transmission is needed that serves as an intermediary gateway between the Web or other parts of the Internet and wireless devices.

### SUMMARY OF THE INVENTION

The present invention is directed to a system and method for providing a data gateway for remote content provider centers or content sponsors to Push data or have it pulled from remote networks, and to broadcast it through an existing in-band on-channel (IBOC) network to iBOC-enabled consumer devices. The gateway particularly serves as a data concentration and management center with several data processing features for facilitation of data transmission. The employed transmission protocol for data pushes from Push initiators to the gateway supports operations such as Push authentication and submission, delivery instructions, result notification, and various scheduling features. The employed transmission protocol for data pushes from the gateway to the targeted consumer devices (within reach of the IBOC broadcast network) supplements the existing network broadcast protocols by enabling continuous broadcast of digitized content without the use of sessions. It supports handling of transmissions errors, various addressing schemes, multiple transmission speeds, prioritization of content, and other scheduling features.

Furthermore, the present invention's Push-Pull gateway provides for an authentication mechanism for verifying the authenticity of Push initiators prior to performing data pushes to client receivers on a network such as an IBOC network. Additionally, the present invention's Push-Pull gateway provides for a mechanism for automatically pulling data from pre-defined channels on remote networks (such as the Internet) before the data is pushed to client receivers on networks such as an IBOC network.

Furthermore, the present invention also provides for a transmission protocol that allows validation of the accuracy and completeness of the pushed data. Moreover, the Push-Pull gateway of the present invention can be interconnected with other Push-Pull gateways for sharing data resources (such as radio resources, billing resources, etc.) and increasing datacasting footprints. At any place, receiver may receive more than one broadcast station. When broadcast stations share the same footprint, they can locally be networked to increase datacasting content. If stations do not share same footprints, they can be networked over a network such as PSTN using a national footprint.

In addition, the Push-Pull gateway of the present invention is able to schedule pre-downloads with a deactivated flag, wherein an alert is sent at a later time indicating when to activate the pre-downloaded content in the client receiver.

### BRIEF DESCRIPTION OF THE DRAWINGS

FIG. 1 illustrates the Push-Pull gateway (iPPG) End-to-End (E2E) system of the present invention.

FIG. 2 illustrates a table outlining a brief description of the various elements that make up the system in FIG. 1, and the interfaces associated with these elements.

FIG. 3 illustrates various functions supported by the ASPs.

FIG. 4 illustrates various entities of the Push message.

FIG. 5 illustrates handling of various data content by the Push-Pull gateway (iPPG) of the present invention.

FIG. 6 illustrates, in greater detail, the functionality of the iPPG of the present invention.

FIG. 7 illustrates the ability of the iPPG of the present invention to Push and Pull data over networks.

FIG. 8 illustrates how incoming data is handled at the receiver's end (an IBOC-enabled consumer electronics device).

FIG. 9 illustrates a table outlining a non-exhaustive list of messages pertinent for pushing data.

FIG. 10 illustrates a table outlining a non-exhaustive list of cause parameters between ASP and iPPG.

FIG. 11 illustrates dimensions associated with fair queuing (FQ) characterizations.

FIG. 12 illustrates a table outlining non-exhaustive list of cause parameters between iPPG and Exciter.

FIGS. 13a-c collectively illustrate the Turbo Broadcast Layer generic encoder header and the software and layer framework of an iBOC consumer electronic device and iPPG respectively.

FIG. 14a illustrates an example showing the steps involved in how the SSAL appends delivery information provided by the content provider center, parses it, determines segment size, and further performs segmentation by iMAC.

FIG. 14b illustrates the example in FIG. 14b with content prioritization and scheduling.

FIGS. 15a and 15b collectively illustrate the method associated with the iPPG of the present invention.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

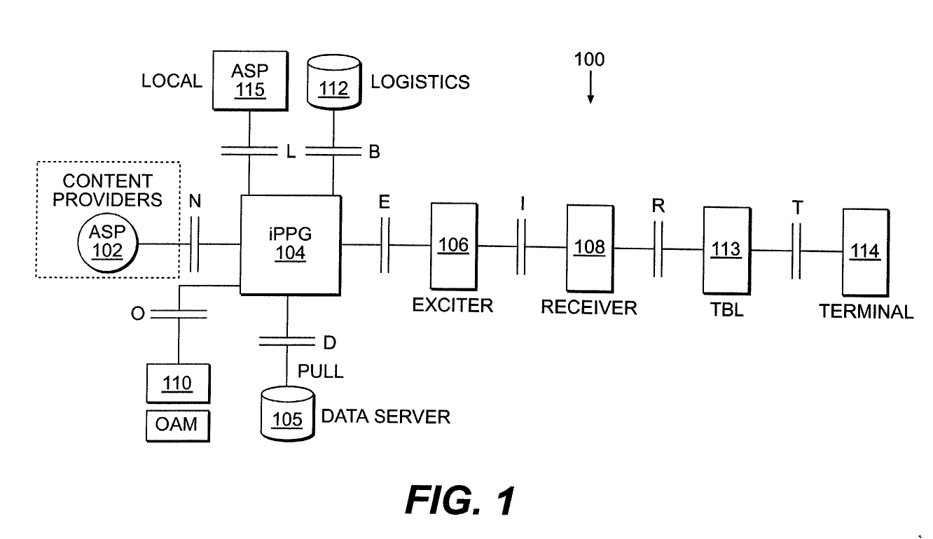

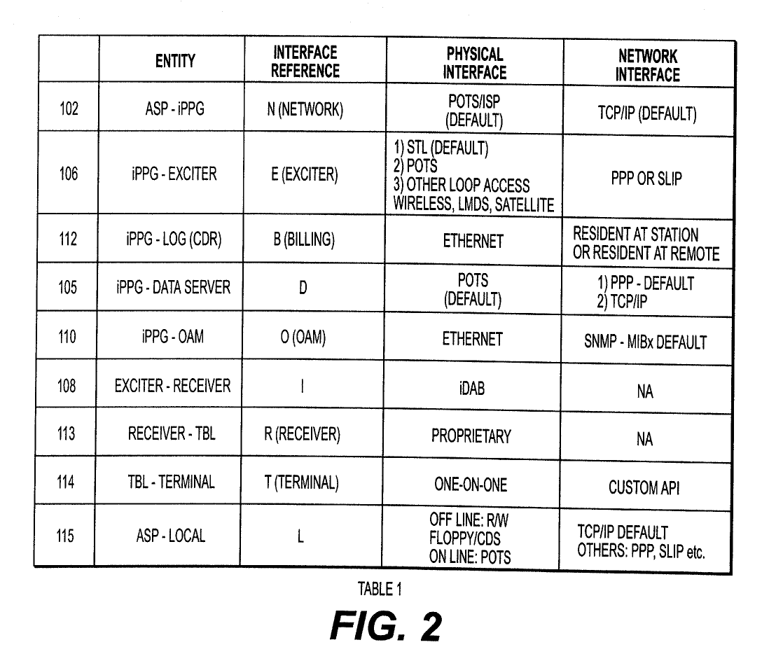

FIG. 1 illustrates the Push-Pull Gateway (hereafter iPPG) End-to-End (E2E) system 100 of the present invention. The system components (to be described below) of the iPPG collectively achieve the Push, Pull, and send features of the present invention's gateway (iPPG). In FIG. 1, the remote application service providers (ASPs) 102 submit (or Push) content, over a network N (e.g., the Internet) via a protocol such as HTTP, to the iPPG 104. Optionally, a local ASP 115 can also be accessed via a local ASP interface L. The iPPG 104 is able to either accept or reject such requests by ASPs 102 and 115. The iPPG is also able to retrieve (or Pull) content (from data server 105) as selected by a station operator over interface D. Data server 105 is an abstraction of data sites which iPPG 104 is able to access to Pull news, traffic, financials, weather, etc. The iPPG of the present invention, with the help of an operation administration module (OAM) 110, prioritizes, schedules, and sends datagrams (over interface E) to the radio transmitter station or iExciter (exciter 106). Receiver 108 acquires the data and a turbo broadcast layer 113 de-encapsulates the data. The data is then displayed on terminal 114. Furthermore, a billing procedure keeps track of all data pushes (via pre-defined logistics 112) from various ASPs for billing purposes. This is done over interface B. As will be detailed later, when in listen mode, the data receiver 108 displays the received data continuously, or, upon demand, as per filtration activated by subscriber. A brief description of the various elements that make up the system in FIG. 1 and the interfaces associated with these elements are described in further detail in Table 1 as shown in FIG. 2.

It should be noted that the ASP 102 is able to communicate with iPPG 104 via various access mediums known in the prior art. However, in the preferred embodiment, the access medium is a plain old telephone system (POTS). Furthermore, the ASP 102 is also able to establish a session using transmission control protocol (TCP) over an Internet service provider (ISP) network. It should, however, be noted that although the preferred embodiment describes establishing connections between ASP and iPPG via TCP, one skilled in the art can envision using other protocols including, but not limited to, the point-to-point protocol (PPP).

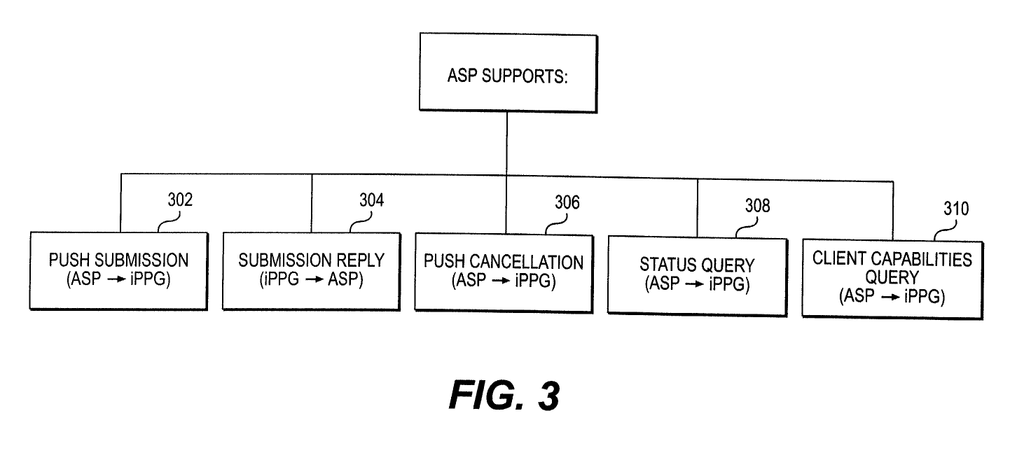

The remote ASPs 102 submit (Push) content using a protocol such as HTTP. In the preferred embodiment, and as shown in FIG. 3, the ASP supports the following functions:

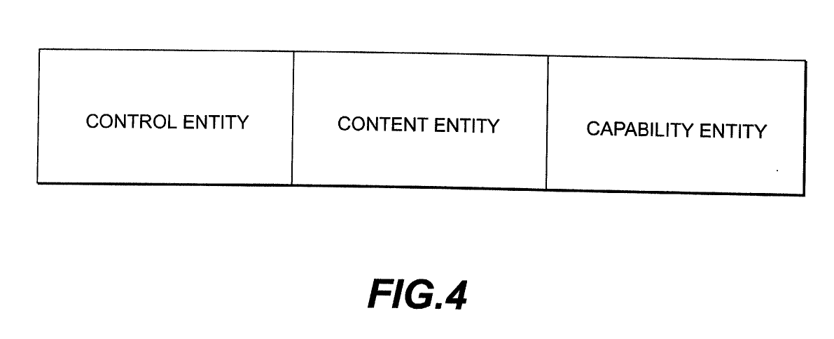

Push Submission (ASP to iPPG) 302: When information is to be sent from ASP to the iPPG of the present invention, the transmission is accomplished via a Push submission from the ASP to the iPPG. It should be noted that this transmission is asynchronous and ASP is able to send information at any time. In the preferred embodiment, the Push message contains three entities: a control entity, a content entity, and optionally a capability entity. FIG. 4 illustrates these entities. The control entity is a header that contains delivery and other instructions destined for the iPPG and the iBOC device. Content entity carries the actual payload of information. For example, payload can be: “Buy One Get One Pizza”. Capabilities, on the other hand, assists the iPPG to perform reformatting of the presentation, so that different terminal 114 types can do presentation of information. This function can also be done in the ASP 102 and Terminal 114, but iPPG 104 gives much more optimization. Furthermore, in the preferred embodiment, the ASP is able to set a confirmation flag for message submission to iPPG and also if it has been delivered over-the-air.

Submission Reply (iPPG to ASP) 304: The Push initiator may request confirmation of successful delivery to iPPG and over the air (OTA) transmission. The message is generated from the iPPG to the ASP when the content has been received by the iPPG. Optionally, the iPPG is also able to notify the ASP that the message has been scheduled for OTA transmission. Furthermore, if the ASP does not receive confirmation, it retries by submitting the information for a predetermined threshold amount of time. It should be noted that no response from the iPPG could mean that the iPPG is down. In the preferred embodiment, it is the responsibility of the ASP to determine when iPPG services become available again. Therefore, the ASP keeps performing random retries, and may give up and retry later.

Push Cancellation (ASP to iPPG) 306: A Push cancellation is possible in the instance that iPPG has accepted the content, but has not yet scheduled an OTA transmission. In this case, the ASP is able to request a cancellation of previously submitted content. The iPPG responds with whether or not the cancellation was successful. It should also be noted that, if the content has been pushed (transmitted) and received by the receiver with deactivate flag, iPPG may perform deletion of content.

Status Query (ASP to iPPG) 308: In this scenario, the ASP is able to request status of previously submitted content and the iPPG responds with current status of submitted content.

Client Capabilities Query (ASP to iPPG) 310: To create better-formatted content for a particular iBOC device, the ASP requests the capabilities of a particular device on the iBOC network. The iPPG maintains a device (114) profile database of registered devices (114) and, in the preferred embodiment, shares this information with the ASP. It should be noted that, although in the preferred embodiment a device (114) profile database is mentioned in conjunction with the iPPG, one skilled in the art can envision the ASP using other means (such as the Internet) to extract such profile information.

As mentioned earlier, the Push download at the iPPG is carried out via protocols such as HTTP. It should, however, be noted that the data receiver does not perform any protocol mapping as the ASP uses standard API, which the end device is equipped with, or optionally, the end device equipment is preloaded with non-standard API by using an original equipment manufacturer (OEM) provided serial interface and drivers. Furthermore, the ASP provides a selection of various fields (services and control categories) as provided by the iPPG. Additionally, if a mandatory element is not initialized, the iPPG performs default initialization.

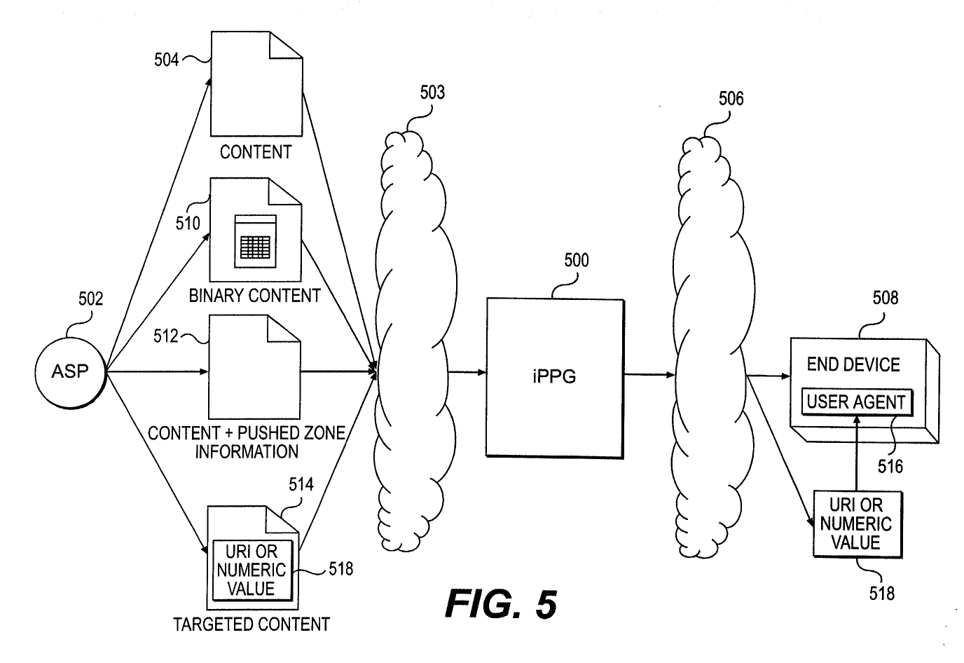

FIG. 5 illustrates handling of various data content by the Push-Pull gateway (iPPG) of the present invention. ASPs 502 are linked to the iPPG 500 via a network 503. As described earlier, the iPPG 500 of the present invention is able Push data content 504 (upon request by the ASP 502) on to various end devices 508 linked via a network 506 such as an IBOC network. In one embodiment, the ASP is able to pre-compile the content to be pushed in binary form 510 to take the workload of the iPPG 500. Thus, when iPPG receives precompiled content, they are forwarded as received to the end devices.

Furthermore, the ASP 502 is also able to request multi-zone coverage which spans to national coverage. Expansion to national coverage is particularly important because it not only increases potential users but also increases the control and specificity of information that is sent to those users. In this instance, the ASP submits information 512 regarding the pushed zone(s), time to broadcast, how many times to broadcast, which users are permitted to receive the information etc., and iPPG 500 routes the ASP 502 request to other networked iPPG. The individual iPPG unit can further add or modify the information transmitted to them, including pushed zone(s), time to broadcast, how many times to broadcast, which users are permitted to receive the information, etc.

In another embodiment, a Push initiator is able to target content 514 to a specific user agent 516 in the device 508. To identify this user agent, the application recognizes an identifier 518 associated with a specific user. This identifier 518 is either a URI or a numeric value. The Push initiator provides the application identifier when the Push content is submitted and is eventually transmitted to the client for dispatching the pushed content to an appropriate user agent 516.

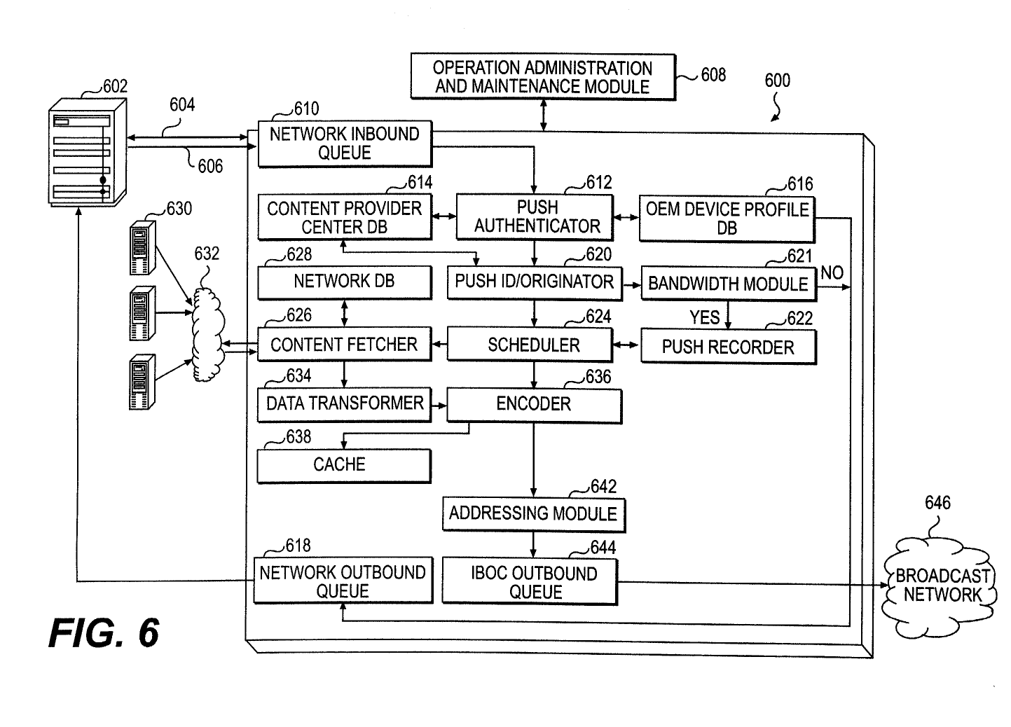

FIG. 6 illustrates, in greater detail, the functionality of iPPG 600 of the present invention. The content provider center 602 establishes session 604 with iPPG 600. The established session provides for a data link such as a link based upon a standard peer-2-peer protocol or any other data communication link. Furthermore, as shown in FIG. 6, an operation Administration and Maintenance Module (OAM) 608 provide function of registration of ASPs to iPPG 600. Content provider center 602 is able to submit a Push request 606 to the iPPG 600, where it is first received by the network inbound queue 610. Next, Push authenticator 612 identifies and authenticates content provider center 602 as the Push initiator. This authentication is performed based upon information stored in content provider center database 614. Furthermore, the Push authenticator 612 checks if the Push message contains any client capabilities queries (a query requesting client's device capabilities), and if so, the queries are passed onto device profile database 616, wherein the device profiles of queried device are extracted and passed on to the network outbound queue 618 for transmission to the content provider center 602. On the other hand, if the Push message is made up of just data content to be pushed (or a request for data content to be pushed), Push ID/originator ID numbers 620 are extracted from the content provider center database 614 and passed onto the Push recorder 622 for storage.

A scheduler 624, then parses control entity of the message and parses such information to bandwidth module 621. Bandwidth module 621 is used for bandwidth management purposes (to be described later). The bandwidth module determines time/schedule for contained instructions and determines if the request is not conflicting. If the time is already assigned, then it parses the information to network outbound queue 618 with available bandwidth calendar. If the request is not conflicting, then it parses such information for storage to push recorder 622. If the instruction extracted by the scheduler 624 includes retrieving data, the content fetcher 626, in conjunction with the scheduler 624 and a network database 628, pulls data from content providers 630 via a network 632, such as the Internet. The pulled data is then transformed and encoded (via data transformer 634 and encoder 636, respectively) into a format supported by the client device 114. Furthermore, data transformer 634 and encoder 636 split the data into octet data blocks, assign serial numbers to all packets, and pass them on to addressing module 642 and cache 638. Lastly, the data from the addressing module is then passed onto the IBOC outbound queue 644 to a broadcast network 646 such as an IBOC network.

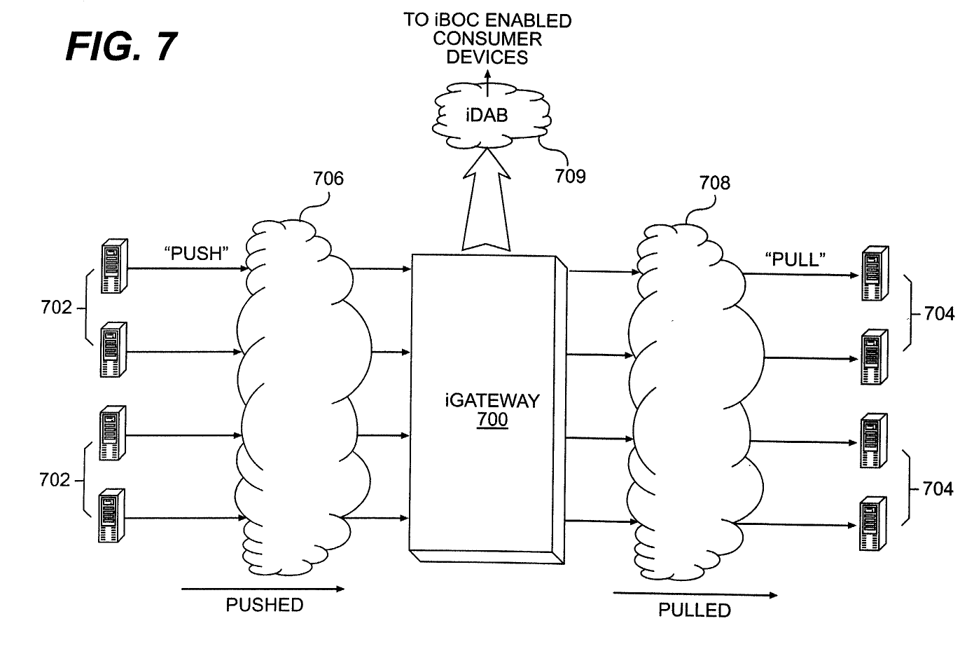

Thus, in summary and as shown in FIG. 7, the iPPG of the present invention is able to get data from various content provider centers 702 (i.e., pushed by 702) and is also able to Pull data from remote content providers 704. The content provider centers and content providers are able to communicate with the iPPG of the present invention via a network (LAN, WAN, wireless, Internet, etc.) 706, 708. Based upon the request from the content provider centers, the data is then pushed via a network 709 such as an IBOC network onto various iBOC enabled consumer devices. In the preferred embodiment, the end device is a consumer electronics device (such as a digital radio receiver) communicating with the iPPG of the present invention over an IBOC network.

It should be noted that although only one iPPG is described in the preferred embodiment, one skilled in the art of networked communication can envision using multiple iPPGs, for distributed processing, wherein such gateways are controlled by one or more centralized gateways. The fact that multiple iPPGs can be used for distributed processing is important because network control can be optimized for many local markets. The distributed processing architecture is similar to conventional nationwide distributed data processing facilities but also includes various iExciter units. For example, an architecture may comprise one iPPG and many transmitters or a set of networked iPPGs and transmitters and a master iPPG or some other combination. Furthermore, although the iPPG, remote content providers, and content provider center are shown to be separate entities communicating over various networks, one skilled in the art may implement them locally in one single entity.

A key advantage of using a networked iPPGs is that control over the transmission and receipt of information may be distributed to various points within the network. That is, for example, local markets may have control over local advertising, while a master iPPG may have control over national content. To implement this system, each of the iPPGs would have their own arbitration procedure which would determine which type of information any specific iPPG would control. That is, where the network consisted of a master iPPG and a number of slave iPPGs and transmitters, individual slave iPPGs and transmitters would determine what local advertising or similar local content (e.g. weather, school schedule, town meeting notices, etc.) to Push during a time slot that was not preempted by the master iPPG. The master iPPG would arbitrate between slave iPPGs (to the extent they were to compete for broadcast space) and would set the broadcast schedule for nationwide data types such as national news, federal emergency signals, national advertising or any other national data type. The programming for such arbitration procedures is well known by those of skill in the art.

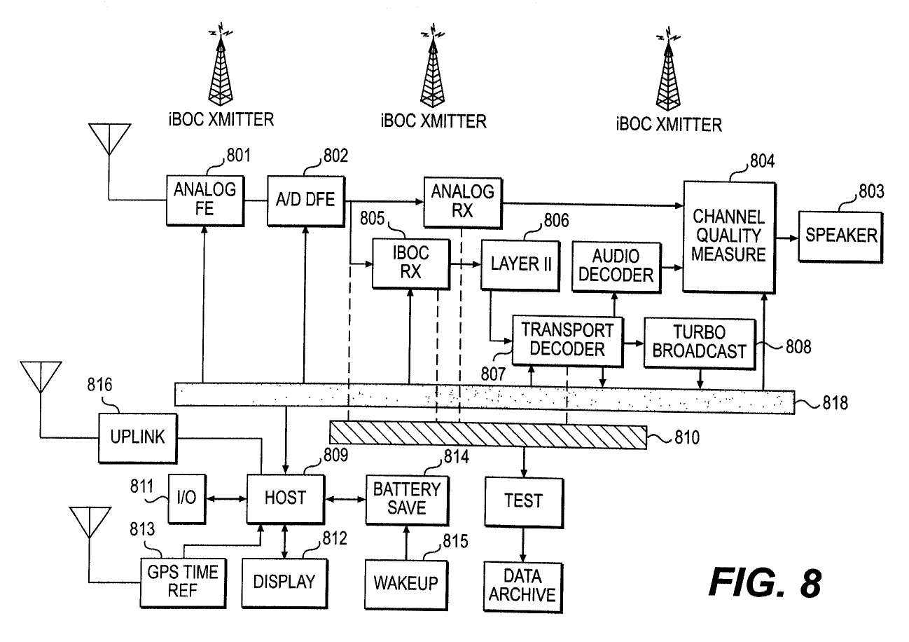

FIG. 8 illustrates how incoming data is handled at the receiver's end (an IBOC-enabled consumer device 800). An antenna 801 located on the receiver first receives incoming data, and detection equipment 802 detects such data and optionally amplifies the signal. Audio signals are converted into audible sounds and are forwarded to the speaker 803. Additionally, the detection equipment 802 uses a channel quality measurer 804 to calculate the quality associated with tuned channel. The received data is then deinterleaved via deinterleaver 805, demodulated via demodulator 806, decoded via a decoder 807 (such as iDAB transport layer decoder), and further decoded via a turbo broadcast layer decoder 808. It should be noted that the processing unit 809 actively controls the above-described deinterleaver, demodulator, decoder, and turbo broadcast layer decoder. Lastly, the processing unit and memory 810 process the decoded data before being presented to the end user device, via a display device 812 (with input 811). A GPS system 813 is also included for advanced content filtration as pushed by iPPG. Additionally, the receiver also has a battery save module 814 that when activated, saves battery energy by ignoring a scheduled Push that is not of interest. A wakeup function 815 is provided for activating the receiver when scheduled transmission is of interest to the receiver. In addition, an uplink module 816 is also provided for uploading profile related information to the iPPG (via an existing access network), and to initiate a “buy” button MMI trigger.

Given below is a detailed description of the iPPG and its components. The iPPG of the present invention can be initialized for the following parameters:

Exciter initialization for continuous Push by iPPG or upon demand by exciter

Audio Bandwidth Calendar. By default, the left over bandwidth is used for supplementary services such as data

Pull schedule

Pull reference address and individual mechanism

Real-time or non-real-time Push. In the preferred embodiment, the real-time Push uses ASP simplex communication with the client (via an intermediary iPPG). Non-real-time is a pre-download where the deactivate flag is on with the condition that the receiver is always on

Initializing customer database. iPPG is able to then decide the policies about who is able to gain access to the iBOC network, who is able to Push content and who is not, and under which circumstances and parameters, etc.

Priority setting (via OAM element management)

Queue prioritization and charge rate association

a. Other data related attributes such as QoS support, timers, etc.

b. Customer database update

Billing cost definition

The iPPG performs a variety of functions, some of which are described below. The iPPG identifies the party initiating a Push request and performs an authentication procedure on the initiator. Furthermore, the iPPG receives information from the ASPs and forwards the content to end devices on a broadcast network such as the IBOC network. Additionally, upon receiving a Push request from an ASP, the iPPG presents its available bandwidth slots (for different times of the day) to the ASP. The iPPG also processes the ASP messages for errors/completion and parses the message for the following requests: query, cancel, replace and confirm. Furthermore, the iPPG also indicates to the ASP when a desired scheduling rate is not achievable. Moreover, the iPPG also provides an acknowledgement of successful delivery of content to the iPPG. This message is transmitted from the iPPG to the Push initiator. In one embodiment, the iPPG includes a storage means for storing advertisements. Thus, ASP can Push content at any time and indicate when to send over-the-air transmissions. The iPPG stores this content. Additionally, as mentioned earlier, the iPPG also prioritizes content for transmission.

The iPPG also performs scheduling operations. The iPPG scheduler makes intelligent decisions as to when and how much is to be transmitted over the air. In an extended embodiment, the iPPG generates and transmits schedule messages indicating the intended schedule of transmissions. It should be noted that in case of discontinuous mode, the schedule message is helpful in minimizing battery in the IBOC data receiver (hereafter iDR) as it allows the iDR to ignore transmissions of messages the subscriber is not interested in.

Moreover, the iPPG also maintains a log of broadcast detail records (e.g., for the purposes of billing). The iPPG also supports 7 and 8 bit data coding schemes for OTA efficiency (local function in iPPG). In one embodiment, to improve OTA efficiency, a numeric identifier is used instead of an URI. In this case, a broadcast interim authority assigns numbers to well-known user agents to avoid the overhead of sending an URI. The broadcast interim authority publishes a list of assigned numerical identifiers. If an iPPG requests to Push content with an application address URI that the iPPG recognizes as an URI that has broadcast interim authority assigned numeric identifier, the URI is replaced with the numeric identifier. In an extended embodiment, the Push initiator requests a numeric identifier to be used (an identifier that is not registered). It should, however, be noted that in this extended embodiment, special care should be taken to avoid collisions. The iPPG is also involved in reliability, rate at which broadcast of message should be repeated, time at which a message should commence broadcasting, determining pre-download with deactivate flag enabled, and determining when to activate the deactivate flag.

Furthermore, the iPPG initiates transmission by sending fixed length short messages to an iExciter, and when necessary, pads the message with appropriate characters to match the fixed length octets. It further maintains flow control when received load indication messages indicate an underflow or overflow situation by the iExciter. Additionally, in one embodiment, the iPPG is able to route the content to selective iPPG (when more than one iPPG exists and are networked). In this embodiment, a centralized gateway: performs intelligent scheduling such that same information is not repeated by each iExciter (assuming the iExciters have similar contour footprint), keeps track of available bandwidth, and instructs receivers to look around for other information. Additionally, iPPG determines the neighboring stations (look around) on which the message should be broadcast provided the neighboring stations are locally networked via iPPG. The iPPG further routes broadcast messages to the appropriate iExciter (in the instance that more than one iExciter exists and these iExciters are networked over a national footprint).

The iPPG also determines the time at which a message should cease being broadcast and subsequently instructs each iExciter to cease broadcast of the message. It also determines the set of zones/iExciters to which a message should be broadcast, and indicates the geographical scope of each message (if networked).

In yet another embodiment, the iPPG provides the Push initiator with client device capability lookup services, letting a Push initiator select the optimal flavor of a particular content for a particular client device. A Push initiator is able to query the iPPG for client device capabilities and preferences, to create better-formatted content for a particular IBOC device. This feature is dependent upon OEMs who have to maintain device profiles in the iPPG. Additionally, broadcasters may track various receiver classes and see if they are registered in its domain. This is especially useful for specialized point-2-point services such as paging.

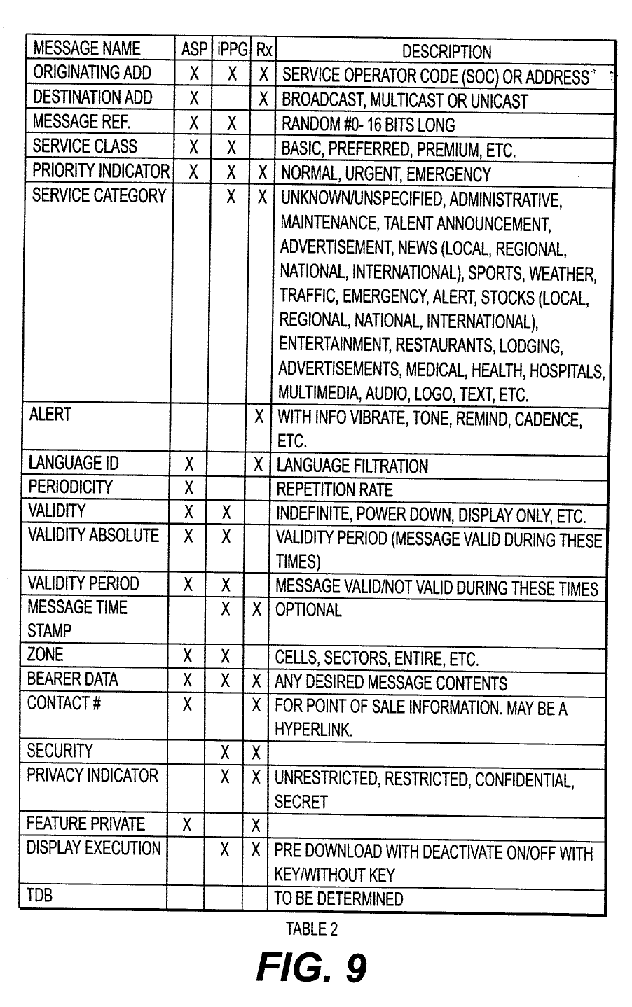

Non-exhaustive messages pertinent for Push are provided in Table 2 illustrated in FIG. 9. These fields are presented as options, which ASPs need to select. In the preferred embodiment, these fields are provided in XML/HTML or by HTTP. It should be noted that a broadcast association allocates a service operator code (SOC). Periodicity, in Table 2, refers to the number of times the content is to be transmitted. In the event of a conflict where the iPPG has more than one message to send at the same time, the iPPG decides the order of such messages as a matter of implementation. The order of transmission of such messages is decided based upon the service request as indicated in control part of ASP header. The service priority field has the following sub-classification:

Extreme High priority: Suspend Current OTA transmission. This is useful in an emergency alert situations.

High Priority: OTA transmission occurs at the earliest opportunity.

Normal: OTA transmission according to the associated repetition rate. If the category is omitted, the default category implied is “Normal” message.

Background/Low: OTA transmissions in the slots left free by messages of category “High Priority” and “Normal”, and can be shared with unscheduled messages. The repetition rate defines the minimum broadcast requirement.

An iExciter identifier field identifies a radio station transmitter defined zone. It should, however, be noted that the FCC has already defined these zones. Thus, the iPPG pulls the deterministic information from the FCC database and uses this information for contour verification purposes. The zone field identifies the iExciter to which the message applies. The billing management layer or OAM layer uses this information for later use. This parameter is a list indicating the number of times the message has been sent to iExciter and if iExciter has completed OTA transmission. It should be noted that the number-of-broadcasts-completed can be set to zero if there were no broadcast messages sent.

Additionally, a failure field identifies the list of radio station transmitter for which the radio station transmitter could not complete the request. Additionally, the failure cause for each radio station transmitter is also indicated.

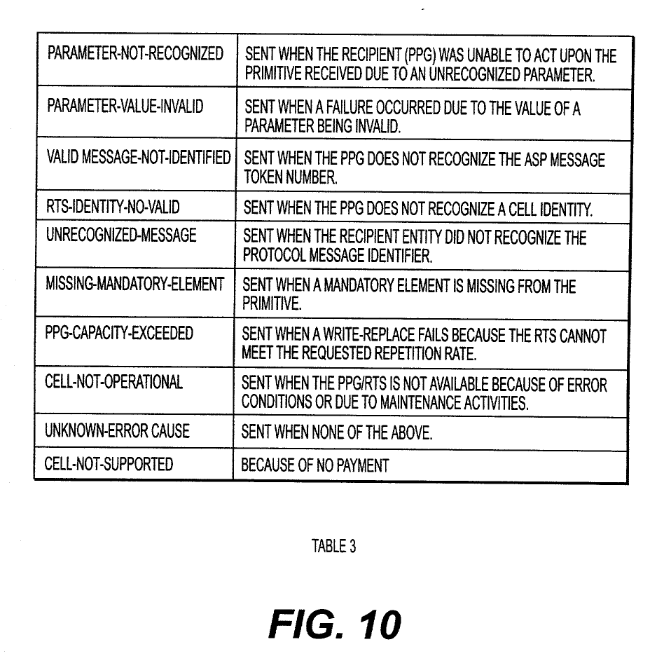

The iPPG also indicates to the ASP, reason(s) why the iPPG is not able to interpret or execute the received submit command. A non-exhaustive list of cause parameters between ASP and iPPG is outlined in Table 3 as illustrated in FIG. 10.

An optional diagnostic field provides additional information associated with the cause parameter and optionally contains parameters that cannot be interpreted/executed between iPPG and Exciter. The iPPG, upon receiving a FAILURE indication from the iExciter, marks this iExciter as failed and does not send any new WRITE/REPLACE requests. When the iExciter has performed successful recovery action, iExciter informs iPPG by sending a RESTART indication. This message implies that the iExciter has resumed OTA operation. It should be noted that the iPPG is also able to trigger a RESTART to the iExciter. In case of an iExciter failure such as iExciter down, over load, hard/soft restart, the initiator (ASP or iPPG) is indicated about the loss of information. If Push initiator does not receive confirmation, it may retry submitting the information for some predetermined threshold amount of time. As mentioned earlier, no response from iPPG could mean iPPG is down.

It should be noted that the iPPG attempts to deliver the content until a predefined timeout expires. The Push initiator and/or policy of the broadcast operator sets this timeout. Thus, the net result of this function is an asynchronous operation from the advertisers point of view (i.e., the initiator need not wait on-line for the iPPG to complete its delivery). Next, a description of local iPPG functions is given below.

The service specific adaptation layer (SSAL) receives service data units by means of standard service access points (SAP). It should be noted that the SSAL is accommodated in the iPPG. Furthermore, the SSAL performs the quality of service (QoS) functions required by the service specific applications such as delay, loss sensitivity, jitter, or differential broadcast services as defined by the operator, etc. Additionally, SSAL operates in two modes of SSAL services: message mode and a streaming mode.

In the message mode, the service specific adaptation layer-service data unit (SSAL-SDU) is passed across the medium adaptation control of the present invention (hereafter iMAC) in exactly one service specific adaptation layer-interface data unit (SSAL-IDU). This service provides the transport of a single SSAL-SDU in one segment. Generally, this mode is used for operation administration and maintenance (OAM) signaling and carries command or a complete message.

In the streaming mode, the SSAL-SDU is passed across the fragmentation interface in one or more SSAL-IDUs. To maintain QoS grade, the bandwidth scheduler may spread the transfer of this SSAL-IDUs across the iMAC interface so that it occurs separated in time. An internal pipelining function in the (receiver) SSAL is applied for providing the means by which the sent SSAL entity initiates transfer to receiving SSAL entity before it has a completed SSAL-SDU available.

Now, a description of content scheduling is given. In broadcasting, prime time is the most appealing time slot for broadcasters and advertisers. But, due to the limited bandwidth, every over the air request at prime time cannot be handled. In a non real-time scheduling scenario, the iPPG of the present invention handles this content transmission as follows. The iPPG transmits the content in advance with receiver display Deactivate Flag Disabled. Thus, at prime time, the Display Flag is enabled. The iPPG may repeat the same information at prime time, provided it has nothing else to transmit.

On the other hand, in a real time scheduling scenario, the iPPG is always aware of the over the air bandwidth availability for a defined calendar. When iPPG is accessed, the ASP is informed regarding the availability of bandwidth and their associated cost. Furthermore, upon some dialogue interaction, the iPPG is able to accept or reject the content to be transmitted over the air.

In yet another embodiment, the iPPG allows other programs, such as bulletin boards, to kick off auto download. For example, using a proprietary file transfer protocol such as iBiquity's® file transfer protocol (iFTP), the iPPG polls information sites such as weather, traffic, stocks, games at pre-defined time periods and broadcasts any extracted information to the end devices.

Scheduling of messages depend on a variety of factors including the priority of messages, i.e., premium service first, followed by bit rate, latency grades, best effort, etc. Some of the other dimensions of scheduling include:

Time at which a message should commence over the air transmission.

Time at which a message should cease over the air transmission.

Rate at which over the air transmission of the message should be repeated.

Pre-download with deactivate flag turned on, and at scheduled time, flag turned on.

In yet another embodiment, schedule messages are generated indicating the intended schedule of transmissions. It should be noted that such schedule messages are helpful in minimizing battery in the iDR, because it allows the iDR to ignore transmissions of messages the subscriber is not interested in. In an additional embodiment, a specific channel for broadcasting the content is selected for over the air transmission.

Additionally, the iPPG is able to copy selective, random or all pushed and pulled content in a separate buffer called the passive queue. Thus, when all content is served from the active queue, the scheduler transmits from the passive queue (the passive queue is a mirror image of active queue, but with a low priority of service). Furthermore, the over the air transmission packets are tagged identifying that the content is from the passive queue. In the preferred embodiment, the receiver maintains the passive queue. Thus, the receiver, when composing messages, ensures completeness by retrieving packets from the passive queue assuming missing in packets in active queue.

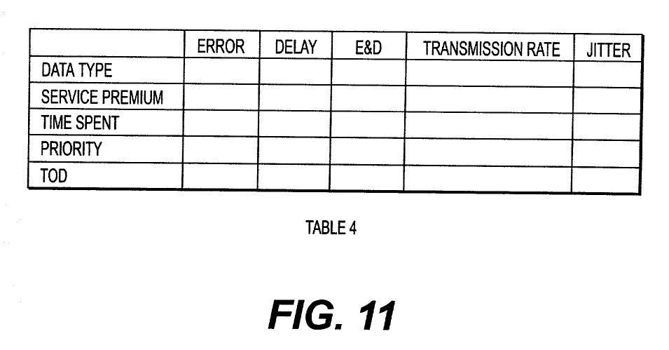

The present invention also includes a pseudo algorithm for bandwidth management called fair queuing. The application kernel looks at the appropriate header bits to determine advert requested QoS grade. It then routes (or pre-loads) the information to one of the fair queues (FQ). Fair queuing is used to prioritize flows per QoS traffic attribute and, at the same time, keeps resource starvation at its minimum. It should be noted that if an FQ flow does not use its assigned bandwidth, other flows are able to use it. Furthermore, each FQ has sub-queues and packets are scheduled so that each flow receives a constant fraction of the IBOC link bandwidth (especially during congestion/prime time). The FQ characterization has several dimensions, some of which are illustrated in Table 4 as shown in FIG. 11.

Each iPPG of the present invention is able to serve multiple ports simultaneously. In this embodiment, the extra traffic is routed or negotiated with third party servers. Furthermore, in another embodiment, fixed/deterministic content such as images, logos, etc., are downloaded during non-peak time. Then, the ASP transmits updated messages as per demand, which are later composed with the pre-downloaded content.

It should be noted that the iPPG of the present invention is able to communicate with any well-known access networks via protocols such as PPP, TCP/IP, Frame Relay, Enhanced General Packet Radio Service (EGPRS), Sirius®, WAP, MediaPlex®, WML, XML, BlueKite® or other known or future protocols.

Furthermore, in an extended embodiment wherein the iPPGs are networked, the iPPG routes the messages to the appropriate iExciter. Additionally, the iPPG determines the geographical scope of each message and communicates with the respective iExciters. The iPPG further determines the time at which a message should cease being transmitted over the air and subsequently instructs each iExciter to cease over the air transmission.

It should further be noted that local transmitters are able to merge their available data bandwidth so that each broadcaster does not need to transmit the same information (i.e., sharing the same contour). Instead, unused bandwidth is used for other data content.

Stations sharing like footprints but with high multipath may schedule contents at the same time. This scheme allows the receiver to determine if information is healthy because it can compare the information transmitted by another station's transmitter. The use of this scheme requires synchronized scheduling.

In an extended embodiment, bulk download such as e-newspaper, e-books, software upgrades, etc., are performed during non-traffic hours such as midnight. Software downloads/upgrades are confirmed via an uplink. Should a particular receiver fail to compose the download, the receiver sends an uplink request regarding missing records. Additionally, in this embodiment, the iPPG gathers statistics to decide if there is a need to rebroadcast some segments of the transmission or to individually send the missing records to each receiver.

The exciter, as shown in FIG. 1, communicates with the iPPG for at least the following:

The exciter accepts continuous push from iPPG or may pull upon demand from iPPG

The exciter generates load indication messages, indicating an underflow or overflow situation

The exciter provides the iPPG acknowledgement of successful execution of commands received from iPPG

The exciter reports a failure to the iPPG when a command received from the iPPG is not understood, or a received command cannot be executed

iExciter status indication such as over loaded, hard/soft restart. In this state, it may loose dynamic attributes of related information; therefore iPPG or ASP need to redownload.

If in non-operational state wait until a restart indication submitted

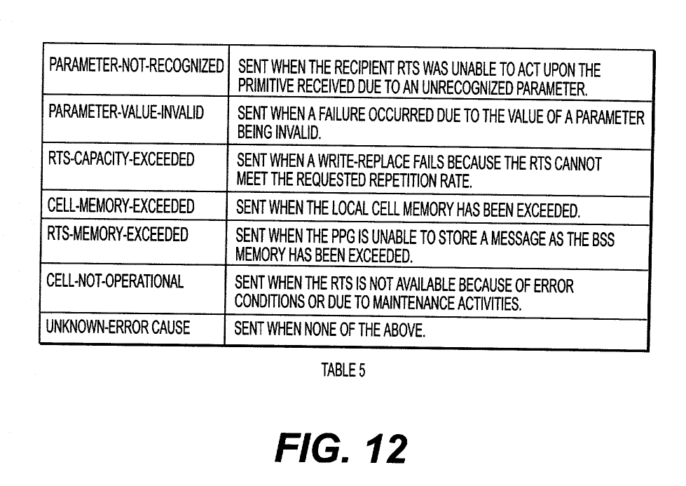

The iExciter indicates to the iPPG the reason why the iExciter was not able to interpret or execute the received primitive. A non-exhaustive cause parameters between iPPG and Exciter are given in Table 5 shown in FIG. 12.

### Turbo Broadcast Layer (TBL)

Turbo Broadcast layer is responsible for transport of datagrams from iPPG to the IBOC data receiver and its user agents. Turbo broadcast layer provides following services:

ISSAL iBOC Service Specific Adaptation Layer

IMAC iBOC Medium Adaptation Control

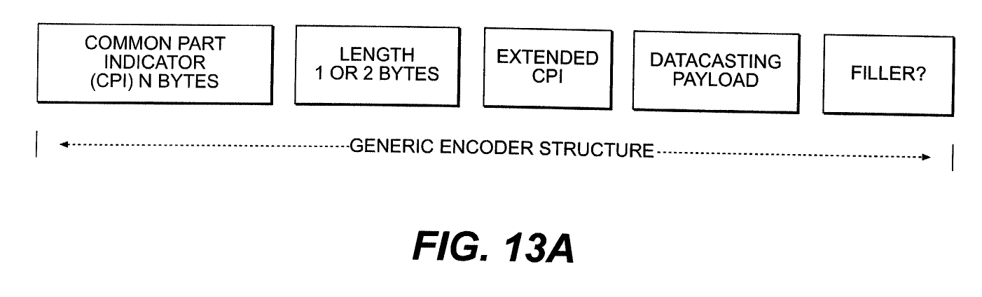

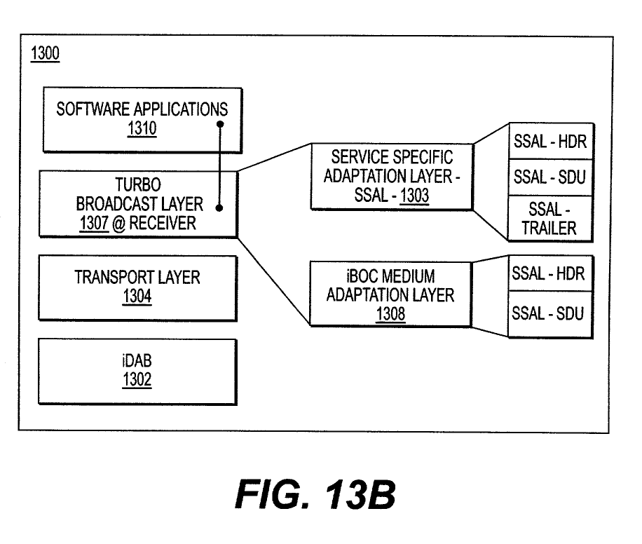

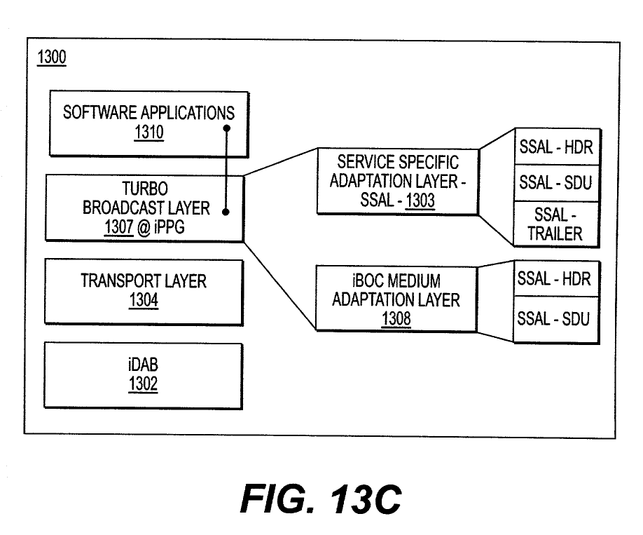

FIG. 13a illustrates an iMAC Generic Encoder Header.

1.1 Common Part Indicator Structure

1.1.1 Protocol Discriminator

One bit field to indicate if protocol is iBiquity defined or private. If private, over the air (OTA) transmission may be blocked.

To block or tunnel with private encoding of third party.

1.1.2 Scope

For differentiated services for Point-2-Group and Point-2-Point. If enabled, extended bit indicator will be set. The extended header will be of varying length to indicate information as necessary e.g., P-2-Group cast address, or key management if paid subscription etc.

1.1.3 Service Grade

Sixteen grades of services with respect to coverage and quality of the radio station. For example for MPS-Data, Service grade is initialized for main primary 1. This means that on the average coverage and quality is as defined in the iBOC specification.

1.1.4 Continue/End

This field to specify if more than 1 service IE are present in a given encoder structure. SSS may use this field to fill up the unfilled bytes of MP-Data bandwidth with some other data e.g. weather.

1.1.5 Extended

This is used for future expansion. The header can be of variable length, for e.g.,

if scope=P2G, then extended bit field is set to indicate group casting address e.g. Ford, Toyota

Or/and if Content Provider Address Originate/Terminate Flag is set, then extended header is used to specify address of Originating content provider, (and or terminating content provider e.g. E.164 or URL). The potential use of this information is to assist the receiver application to Pull the desired information when buy MMI is triggered.

1.1.6 Generic Control Flags

Generic control flags are listed for MPS-Data service.

1.1.6.1 Repeat

This field may be used by the server to determine if it needs to refresh the service Q.

If desired the receiver application may use this bit to determine if it needs to cache the content.

1.1.6.2 Activate

SSS may schedule short term pre-down load with activate flag=disabled. It may enable later. Once enabled, the receiver system can Pull the cached information upon demand.

1.1.6.3 Receiver Alert

This flag is used to assist the receiver to use OEM defined MMI means to alert the listener via an OEM generated blink/flash or audible tone.

1.1.6.4 Audio Mute

Application may set this flag to allow receiver to put main audio service in background

1.1.6.5 CP Address

If the flag is set, X bytes in Extended Header will identity:

Content Provider Originating Address

Content Provider Terminating Address (e.g., Direct Point of Sale)

1.1.6.6 Device Type

This flag is used to assist the receiver system not to present content which may cause distraction if device is installed in front panel of automotive.

1.1.6.7 Other place holders for future expansion.

1.2 Length

This indicates the length of the payload. This length is configurable to allow future modifications. If extended header bit is set, length is greater of burst size {MPSA-Data or packet}.

1.3 Extended CPI

The use is dependant upon extended bit in CPI. This suggest that encoder header is of variable length. Possible use of E-CPI are discussed above. Place holder for future expansion e.g. but not limited to are: software of grades, segmentation, multiple iMAC frames codec, data rate notification, look around, broadcast system info, service addition/deletion security management etc.

1.4 Datacasting Payload

Allows eight main service groups to be supported by iDatacasting and its associated ubiquitous sub types.

1.5 Filler

No filler. Bandwidth gets added in left over bandwidth at the iExciter or filler with configurable stuff.

1.6 Extended Header

This field provides a set of data for performing the functions of the IBOC services such as, but not limited to:

Authentication

Content category level

Content rating

Content type

Data service priority

Encryption modes

External service interface

Synchronization

Transactions

Markup language

Frame fragmentation and reassembly at receiver

Content security by using SDMI

Service Header Data—Service header data provides information to the receiver about the data services that exist on a channel. The fields may include, but is not limited to, Channel ID, Header size, Data Service Size, Service Count, Service Mask, Service Location.

Data Service Header—This information describes the size of the data service, as well as modes and methods of encryption and authentication. The list of fields may include but will not be limited to: Data Service Size, Data Service Priority, Encryption Mode, Encryption Bit Size, Encryption Public Key, Authentication Mode, Time Stamp, Authentication Public Key, Digital Signature Length, Digital Signature.

Data Service Data File—The data service data file is a generic data structure that characterizes a data service and carries data service content. The list of fields may include, but will not be limited to: Synchronization Cue, Sender Time Stamp, Receiver Time Stamp, Domain ID, Content Rating, Content Category Level, File Size Number, File Size Magnitude, Status Flags, Event ID, Event Indicator, Group ID, Content Type, User Data, Reserved Fields, User Defined Fields.

Synchronization Data—Synchronization data is data transmitted in relation to the audio data. The data consists of a fixed number of fixed size fields that can be used by a device to time different events. The list of fields may include, but is not limited to: Synchronization Cue, Synchronization Type, Length, Spacing, Event Transmission performance requirement of the synchronization data.

Service Mask—A service mask is information associated with a data service that characterizes the nature of the service and its functional requirements. This area of the specification defines the structure and meaning of information in the service mask.

The Turbo Broadcast Layer is protected with standard HCS and payload by well known CRCs.

FIGS. 13b and 13c collectively illustrate the software and layer framework 1300 of a consumer device (FIG. 13b) and iPPG (FIG. 13c). As explained above, data transmission from one communication system to another, via a network, requires data flow through each of the involved network layers on the source system down to the physical link where it is passed on to the peer physical layer of the respective adjacent communication system, until it is picked up by the peer layers of the destination system. Here, the data packets flow through the respective peer layers of the destination system before it is processed by software application and, for example, be viewed on a display device. The employed protocols for the data transmission implement the necessary functions of the respective layers and set forth the format by which the data is transmitted between the involved communication systems.

In general, the lowest layer is represented by the physical layer 1302 where the data bit stream is synchronized and transmitted/received by a radio carrier frequency signal. Above the physical layer 1302 is transport layer 1304. Implemented on top of the transport layer 1304 lies Turbo Broadcast Link Layer (TBL) 1307 consisting of Service Specific Adaptation Layer (SSAL or rSSAL in the case of the receiver's SSAL) 1303, and IBOC Medium Adaptation Layer (IMAC or rIMAC in the case of the receiver's IMAC) 1308.

The TBL can reside in the iPPG, if the iPPG and the exciter are located in the same location or TBL can reside in the Exciter if iPPG and exciter are connected via microwave STL (Studio Transmitter Link). In the preferred embodiment, TBL is preferred in iPPG, if STL is a bi-directional link. In other instances, TBL resides in the exciter.

The main functions of the TBL (transmit side) are: to manage upper level concatenation, file segmentation, address management, header formatting, filler, CRC generation, and Broadcast Change Notification (BCN). Receiver side TBL on the other hand perform the following functions: CRC verification, defiler, TBL frame assembly, repeat discard, address read, BCN wake, and sequence delivery.

The TBL is sandwiched between transport layer 1304 and API 1310 (FIG. 13b). A stack is defined as a bundle of layers necessary for network communication through which all data passes at both ends of the data communication system. Transport network stack 1304 is therefore responsible for the proper end-to-end transport of data PDUs. It should be noted that the network stack 1306 is missing in the receiver's figure (FIG. 13b), because this stack comes from the uplink device (if any). On top of stack 1306 is an embedded TBL 1304 and following that are application programming interface 1310. The aforementioned software applications 1310 are usually pre-implemented on consumer devices and the computer system deployed as iPPG when transmitting data through computer networks. TBL 1307, however, should be initialized in order to take advantage of the present invention.

TBL 1307 of the iPPG is responsible for the provision of healthy delivery of data from iPPG to consumer electronics devices through the IBOC network by: presenting a choice of data transmission rates, minimizing the total amount of data overhead transmitted over the IBOC network, reliable and efficient delivery of downlink, alarm, and maintenance messages, anticipating and intelligently handling error conditions and message latency, spreading data traffic rather than incurring high burst rates, supporting terminal topologies, concepts, and protocols, as well as a portable, expendable, and flexible network hierarchy.

TBL 1307 of the receiver implements the TBL protocol setting forth the format rules of networked communication in order to achieve TBL's 1303 and 1308 aforementioned functions. It should, however, be noted that existing protocols, such as FLEX ERMES® or Pocas®, are designed for paging and because of their slow transmission speeds are not suitable for continuous broadcasting of content and graphics. Furthermore, in this scenario, the consumer devices may fail to receive some of the data packets. On the other hand, TBL protocol avoids data latency and loss of data packets by synchronizing and scheduling data broadcasts to various transmitters, and thereby maximizing the distribution link, allowing multiple transmission speeds, sophisticated error detection and correction mechanisms, pooling and scheduling available bandwidth, and repeating broadcasts.

The iPPG SSAL 1303 performs functions required by the service specific applications such as delay, loss sensitivity, jitter, or differential broadcast services such as audio, video, data, multimedia message service as defined by the content provider(s). These parameters are reflected in the iMAC header and intelligently used by the exciter physical layer 1302 (FIG. 13b), by placing sensitive content into non-sensitive regions of the broadcast spectrum. As previously mentioned, the iPPG SSAL features a message mode and a streaming mode.

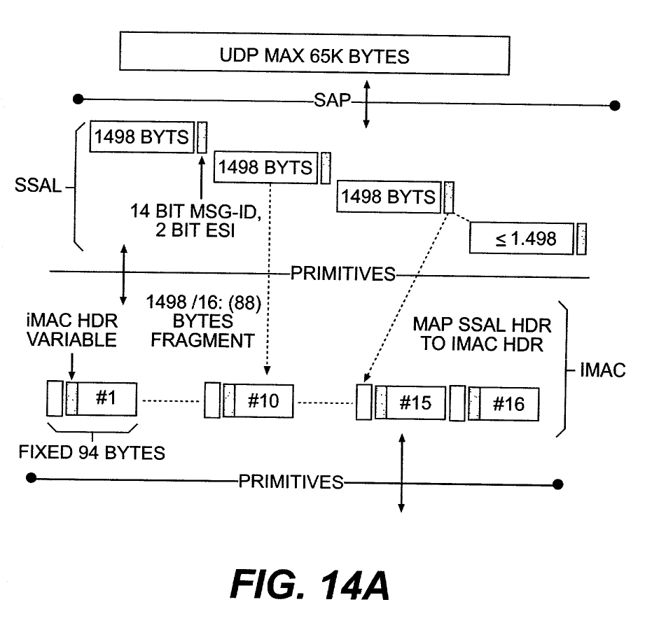

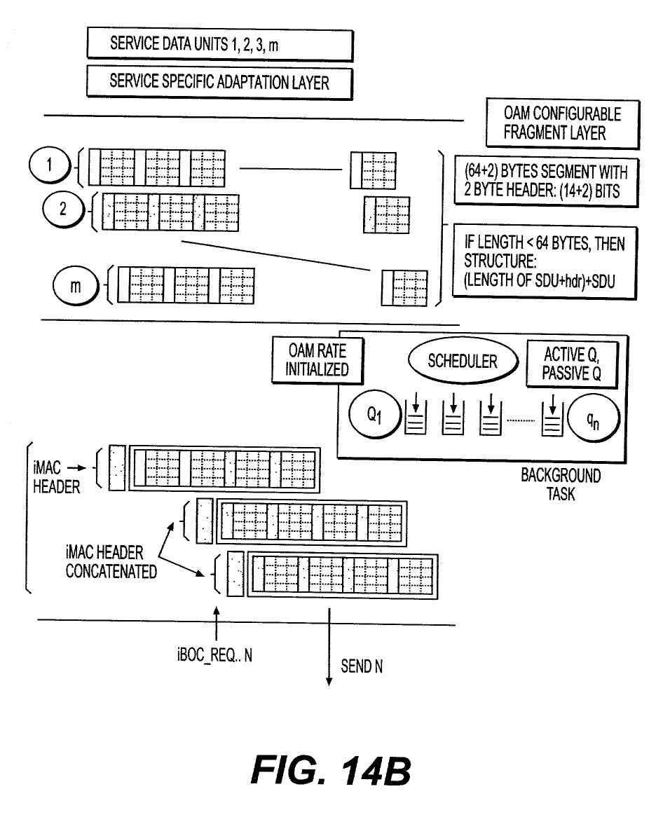

The receiver's iMAC 1308 (FIG. 13b) performs functions such as address determination, look-around, sequenced assembly of data packets, etc. In the receiver assisted look around, the receiver determines if the channel quality is bad (via channel quality measure in FIG. 8) and makes a decision on which channel to pick for retrieving data, if any. This method is receiver assisted. Similarly, the receiver performs a look around as directed by iPPG. This method is iPPG assisted in which the iPPG sends a message (in its control channel) to only look for some specific broadcast frequencies. This allows for increased virtual bandwidth. Furthermore, FIG. 14a illustrates the steps involved in how the SSAL parse the delivery information provided by the content provider center, and determines segment size and identifier, QOS transmission errors and other parameters for FM or AM transmission. The iMAC appends intended receiver addressing (Point-2-Group), if possible combines multiple SSAL in a given iMAC frame and wait for the transport layer to full the iMAC PDU to be transmitted over the air. FIG. 14b is similar to the scenario in FIG. 14a, but it further illustrates content prioritization and scheduling.

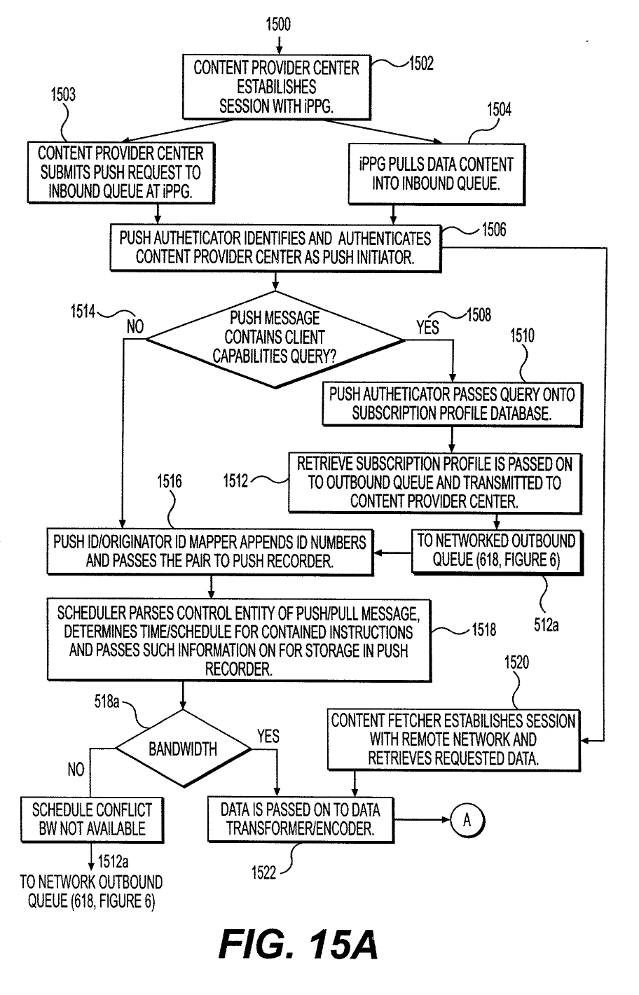

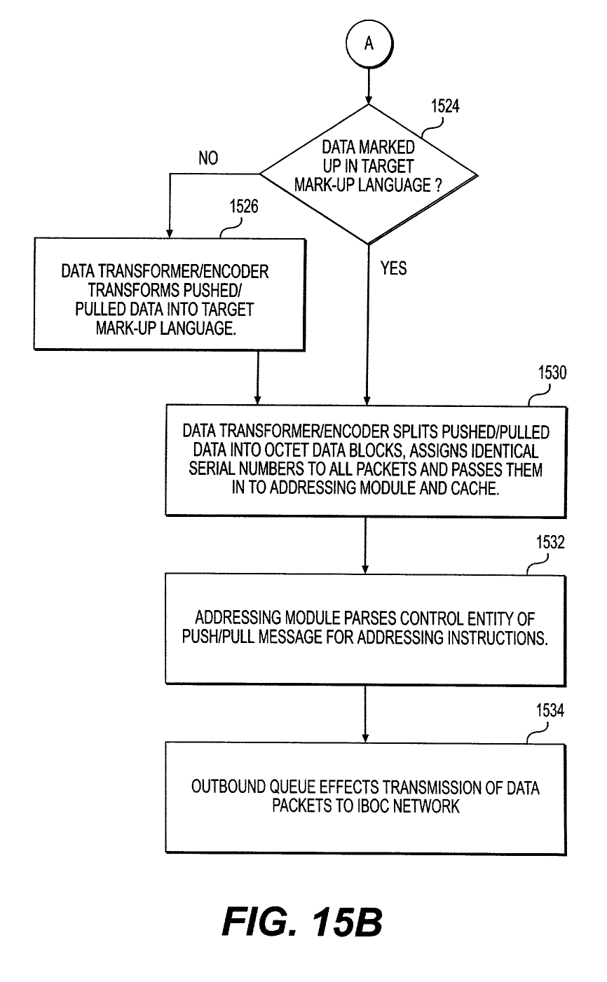

FIGS. 15a and 15b collectively illustrate the method 1500 associated with the iPPG of the present invention. At step 1502, the content provider center contacts the iPPG via a communication link using well known protocols such as TCP/IP, PPP, etc., and establishes a request/response session, wherein the iPPG acts as a server and the content provider center as a client. Using a Push/Pull protocol the content provider center either, at step 1503, submits a Push request to the iPPG or, in step 1504, pulls from the data content provider. The data is cached to the inbound queue of the iPPG. It is understood that the push/Pull download protocol is only one option for transmitting Push content to the iPPG. Push/Pull protocol is tunneled through existing protocols such as HTTP. As mentioned earlier, the Push message consists of the following three entities: control entity, content entity, and capability query entity.

The control entity is marked up in a mark up language such as Extensible Markup Language (XML) and contains delivery instructions, such as originating and destination address, message ID, priority indicator, message category, repetition rate, message time stamp, privacy indicator, status request, client device capabilities query, or cancellation request for previously submitted content. It is understood that the preceding list of possible delivery instructions is non-exhaustive and should not be used to limit the scope of the present invention. These later get mapped to the turbo broadcast layer.

Furthermore, as mentioned earlier (in the bandwidth module description), if the content provider center or content providers themselves desire to fix the bandwidth, then the iPPG is capable of supporting a fixed bandwidth with a defined QoS. During this reservation period, the iPPG simply acts as a transparent conduit. It is the responsibility of the content provider center to make use of the close protocol at the remote receiving consumer device.

The client device capabilities are preloaded into the iPPG by Original Equipment Manufacturers (OEMs). Content provider centers are able to query in a markup language format (such as XML) and request the capabilities of a particular device in the IBOC network. Such information is contained in a client device database, which may also receive device profiles from consumer electronic devices (with uplink capabilities) via a datalink inbound queue, over a circuit or packet access network.

Following the establishment of a session and submission of a Push or Pull request initialization via OAM at steps 1502 through 1504, the Push authenticator identifies and authenticates at step 1506, the content provider center as Push initiator. Such authentication is achieved by means of session-level certification (e.g., the well-known SSL technology), by use of object-level certificates (i.e., encryption of the content on an end-to-end basis), HTTP authentication (e.g., user/password pairs or digest based authentication), or a combination of the preceding methods. Such authentication is achieved using various protocols (e.g., CHAP). It should be noted that the methods outlined are not exhaustive.

If such authentication is successful, and if the content provider query contains a device capability request 1508, Push authenticator passes, at step 1510, such query on to a client device profile database where device profiles of registered OEMs of consumer devices are stored. The requested profiles are then, at step 1512, retrieved from the OEM device profile database and submitted to the outbound queue for transmission to the content provider center, which is subsequently able to provide better and more customized data according to the consumer device's capabilities.

If no client query was submitted 1514, or after completion of step 1512a, Push ID/originator ID of the respective content provider center is extracted 1516, and this information is then passed on to the Push recorder. Push recorder stores the ID pair of the message and all data relating to it, such as time of transmission to the IBOC network, repetition rate, and other relevant details such as amount of bandwidth, number of transmissions, grade of service are recorded for billing purposes. Thus, when content provider center wants to perform a Push to client, it may query the iPPG for capabilities of the remote consumer electronic device (such as classifications, e.g., class A device, class B device, class C device, etc.). Class A is defined as the state of the art receiver (i.e., maximum resolution, memory, MIPS, uplink, GPS) and classes B, C, etc., are low end receivers with minimum display etc.

Subsequently, at step 1518, the scheduler parses the respective control entities of the incoming Push messages, determines a time schedule for the broadcast rate, grade of requested service, time of broadcast commencement, time of pulling of content according to Pull requests, and synchronizes such broadcast and pulling schedules, as well as available bandwidths. At step 1518a if bandwidth is not available, iPPG submits a bandwidth calendar to the content providers. The content provider may select from the available calendar and re-enters at step 1518.

According to the determined time schedule, and in the case of a Pull request submitted at step 1502, the content fetcher, at step 1520, establishes a session with appropriate server on remote network area and retrieves the requested data files. If no Pull request has been submitted at step 1502 or after completion of step 1520, the pushed/pulled data is passed on to data transformer/encoder (TBL) at step 1522. If the data submitted to data transformer/encoder needs to be transformed into a suitable mark-up language 1524 for consumer electronic device(s), the data transformer/encoder effects such data transformation by the use of translation software in step 1526. Information captured at steps 1516, 1518, 1520, and 1524 gets mapped to turbo broadcast layer. At step 1530, TBL-SSAL splits the data into multiple octet data blocks, assigns identical serial numbers to all those packets, and passes them on to the cache and addressing module. In step 1532, the addressing module then parses control entity of the push/Pull message (destined for receiver) for addressing instructions, such as broadcast, multicast, or point-2-point.

Additionally, in step 1530, the TBL-iMAC is invoked which performs functions like segmentation of TBL-SSAL, sequence numbers insert, payload FEC generate, CRC of iMAC, target address append and setting of broadcast change notification flags. It then waits for IBOC physical layer command, i.e., bits are given to the IBOC layer upon demand by the IBOC. Then, at step 1534, outbound queue effects transmission of the data packets to the various transmitters in the IBOC network from where it is transmitted to consumer device(s) that listen to IBOC channels.

TBL-SSAL, at step 1522, performs service specific adaptation function such as rearranging packets to maintain QoS grade which include calculation of jitter, delay, repeat, reorder of packets, system related messages, service indicators, such as alert to pick up pre-download graphics, station URI, station logo, promotion tags, etc.

Furthermore, the present invention includes a computer program code based product, which is a storage medium having program code stored therein, which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Implemented in computer program code based products are software modules for: receiving a Push request from a content provider center, authenticating the content provider center as the originator of the Push request, parsing the Push request for push, pull, broadcast times, and addressing directives, fetching data content to be pulled over a network based upon the parsed directives, encoding the fetched data, and transmitting the encoded data based upon the parsed broadcast times and the addressing directives. The above described functional elements (and icons therefore) are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network communications, mark-up language and protocol programming.

The above described system and method for the effective implementation of a Push-Pull Gateway between iBOC enabled consumer devices and remote content provider centers has been described with respect to particular embodiments thereof. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, choice of communication protocols, number of transmitters, and number of Push/Pull gateways used.

I claim:

1. A datacasting Push-Pull gateway for scheduling over the air transmissions of data content, said gateway working in an event driven manner controlled via an operation administration and maintenance module, said event driven gateway comprising:
a network inbound queue for the reception of instructions related to said data content transfer;
a scheduler for parsing said instructions for directives comprising:
Push and Pull transmissions, and
broadcast times and schedule related to said transmissions;
a content fetcher for the extraction of said data content based upon said directives;
a data processor for encoding said extracted data content;
an addressing module for parsing said instructions for extracting addressing instructions, and
an outbound queue for broadcast transmission of said encoded data content based upon said parsed addressing instructions and said schedule.

2. A datacasting Push-Pull gateway for scheduling over the air transmissions of data content, as per claim 1, wherein said gateway further comprises a device profile database, said device profile database holding profiles associated with iBOC enabled consumer devices, and each of said profiles defining one or more specific data content formats for said transmission via said outbound queue to one or more clients.

3. A datacasting Push-Pull gateway for scheduling over the air transmissions of data content, as per claim 2, wherein said instructions related to data content transfer further comprises a request for identifying said one or more specific data content formats associated with one or more specific clients.

4. A datacasting Push-Pull gateway for scheduling over the air transmissions of data content, as per claim 1, wherein said gateway further comprises a Push ID/Originator ID extractor for extracting a unique ID associated with a sender of said received instructions, assigning a unique ID associated with said Push transmissions, and storing said Push ID/Originator ID in a Push recorder.

5. A datacasting Push-Pull gateway for scheduling over the air transmissions of data content, as per claim 4, wherein said gateway further comprises a Push authenticator for authentication of said sender of said received instructions.

6. A datacasting Push-Pull gateway for scheduling over the air transmissions of data content, as per claim 4, wherein said outbound queue further comprises a network outbound queue and a broadcast outbound queue, said network outbound queue transmitting data content to said sender of said received instructions and said broadcast outbound queue transmitting data content to an external broadcasting network.

7. A datacasting Push-Pull gateway for scheduling over the air transmissions of data content, as per claim 6, wherein said broadcast network is an in-band on-channel (IBOC) network.

8. A datacasting Push-Pull gateway for scheduling over the air transmissions of data content, as per claim 1, wherein said gateway further comprises a bandwidth module for bandwidth management, said bandwidth module maintaining queues and prioritizing flows per quality of service (QoS) traffic attributes while keeping resource starvation to a minimum.

9. A datacasting Push-Pull gateway for scheduling over the air transmissions of data content, as per claim 8, wherein said queues further comprise an active queue and a passive queue, said active queue storing data content currently being transmitted and said passive queue storing pushed and pulled data content.

10. A datacasting Push-Pull gateway for scheduling over the air transmissions of data content, as per claim 1, wherein said gateway further comprises a cache for holding said data content to be transmitted.

11. A datacasting Push-Pull gateway for scheduling over the air transmissions of data content, as per claim 1, wherein said instructions related to said data content transfer comprise precompiled binary data for transmission.

12. A datacasting Push-Pull gateway for scheduling over the air transmissions of data content, as per claim 1, wherein said scheduler further parses for pushed zone information defining various time zones for broadcasting said encoded data content.

13. A datacasting Push-Pull gateway for scheduling over the air transmissions of data content, as per claim 1, wherein said instructions include a unique identifier, said identifier used in targeting said transmitted data content to a specific user agent.

14. A datacasting Push-Pull gateway for scheduling over the air transmissions of data content, as per claim 13, wherein said identifier is an URI or a numeric value.

15. A datacasting Push-Pull gateway for scheduling over the air transmissions of data content, as per claim 1, wherein said data processor further comprises a data transformer and a data encoder, said data transformer converting said extracted data content into a specific format and said data encoder encapsulating said extracted data content in a specific format.

16. A datacasting Push-Pull gateway for scheduling over the air transmissions of data content, as per claim 15, wherein said encoder is TBL encoder.

17. A datacasting Push-Pull gateway for scheduling over the air transmissions of data content, as per claim 1, wherein said gateway communicates to external networks via any of the following protocols: point-to-point protocol (PPP), hypertext transfer protocol (HTTP), or wireless access protocol.

18. A datacasting Push-Pull gateway for scheduling over the air transmissions of data content, as per claim 1, wherein said transmitted data content is in one of the following formats: binary, plain text, HTML, XML, or WML.

19. A datacasting Push-Pull gateway for scheduling over the air transmissions of data content, as per claim 1, wherein said gateway further comprises a timer for tracking a predefined timeout for which transmission of data content occurs.

20. A datacasting Push-Pull gateway for scheduling over the air transmissions of data content, as per claim 1, wherein said gateway is networked for synchronized scheduling with one or more similar gateways and said transmitted data propagates through said network of gateways before reaching one or more client devices.

21. A datacasting Push-Pull gateway for scheduling over the air transmissions of data content, as per claim 1, wherein said parsed directives further include any of the following: time at which transmission is to commence, time at which transmission is to cease, or rate at which data content to be transmitted needs to be repeated.

22. A datacasting Push-Pull gateway for scheduling over the air transmissions of data content, as per claim 1, wherein said information is extracted over a network.

23. A datacasting Push-Pull gateway for scheduling over the air transmissions of data content, as per claim 22, wherein said network is any of the following: local area network, wide area network, wireless network, or Internet.

24. A datacasting Push-Pull gateway for scheduling over the air transmissions of data content, as per claim 1, wherein said gateway further comprises a network database supplying the content fetcher with locations of remote databases from which information is to be extracted.

25. A datacasting Push-Pull gateway for scheduling over the air transmissions of data content, as per claim 1, wherein said encoded data content is in a digital broadcasting format suitable for reception via a digital consumer radio receiver.

26. A method for scheduling over the air transmissions via an event driven Push-Pull gateway, said method comprising the steps of:
a. receiving a Push request from a content provider center;
b. authenticating said content provider center as originator of said Push request;
c. parsing said Push request for push, pull, broadcast times, and addressing directives;
d. fetching data content to be pulled over a network based upon said Push and Pull directives;
e. encoding said fetched data, and
f. transmitting said encoded data to clients based upon said broadcast times and said addressing directives.

27. A method for scheduling over the air transmissions via an event driven Push-Pull gateway, as per claim 26, wherein said method further comprises the step of accessing a subscription profile database to identify one or more specific data content formats associated with said clients.

28. A method for scheduling over the air transmissions via an event driven Push-Pull gateway, as per claim 27, wherein said method further comprises the step of receiving a request from one or more of said clients identifying said one or more specific data content formats associated with data content transmission.

29. A method for scheduling over the air transmissions via an event driven Push-Pull gateway, as per claim 26, wherein said encoded data content is in a digital broadcasting format suitable for reception via a digital consumer radio receiver.

30. A method for scheduling over the air transmissions via an event driven Push-Pull gateway, as per claim 26, wherein said method further comprises the step of maintaining a cache for holding said encoded data content for transmission.

31. A method for scheduling over the air transmissions via an event driven Push-Pull gateway, as per claim 26, wherein said received Push request further comprises a unique identifier, said identifier used in targeting encoded data to a specific user agent associated with said client.

32. A method for scheduling over the air transmissions via an event driven Push-Pull gateway, as per claim 31, wherein said identifier is an URI or a numeric value.

33. A method for scheduling over the air transmissions via an event driven Push-Pull gateway, as per claim 26, wherein said received Push request further comprises information defining various time of day and zones for broadcasting encoded data content.

34. A method for scheduling over the air transmissions via an event driven Push-Pull gateway, as per claim 26, wherein said method further comprises the step of converting said fetched data content into a specific format.

35. A method for scheduling over the air transmissions via an event driven Push-Pull gateway, as per claim 34, wherein said specific format is any of the following: plain text, binary data, HTML, WML, or XML.

36. A method for scheduling over the air transmissions via an event driven Push-Pull gateway, as per claim 26, wherein said network is any of the following: local area network (LAN), wide area network (WAN), wireless networks, HFC Network, LMDS satellite network, or the Internet.

37. A business method for generating revenue based upon scheduling and pushing requested data content via a Push-Pull gateway, said method comprising the steps of:
a. receiving a Push request from a content provider center;
b. authenticating said content provider center as originator of said Push request;
c. parsing said instructions for push, pull, broadcast times, and addressing directives;
d. identifying a bandwidth associated with transmitting said received Push request;
e. identifying transmission slots available for said identified bandwidth and costs associated with each of said identified slots;
f. transmitting to said content provider center said identified transmission slots and said associated costs;
g. receiving a choice from said content provider center regarding which of said identified slots is to be used for transmission;
h. extracting data content over a network based upon said parsed directives;
i. encoding said extracted data content;
j. transmitting said encoded data content based upon said broadcast times and said addressing instructions to one or more end devices, and
k. calculating a cost associated with said choice of transmission slot and charging said content provider center for said calculated cost.

38. A business method for generating revenue based upon scheduling and pushing requested data content via a Push-Pull gateway, as per claim 37, wherein said encoded data content is in a digital broadcasting format suitable for reception via a digital consumer radio receiver.

39. An article of manufacture comprising a computer usable medium having computer readable program code embodied therein that schedules over the air transmissions via an event driven Push-Pull gateway, said article comprising:
a. computer readable program code receiving a Push request from a content provider center;
b. computer readable program code authenticating said content provider center as originator of said Push request;
c. computer readable program code parsing said Push request for push, pull, broadcast times, and addressing directives;
d. computer readable program code fetching data content to be pulled over a network based upon said Push and Pull directives;
e. computer readable program code encoding said fetched data, and
f. computer readable program code transmitting said encoded data based upon said broadcast times and said addressing directives.

40. An article of manufacture comprising a computer usable medium having computer readable program code embodied therein that schedules over the air transmissions via an event driven Push-Pull gateway, as per claim 39, wherein said article further comprises computer readable program code for encoding data content in a digital broadcasting format suitable for reception via a digital consumer radio receiver.

41. A datacasting system for scheduling over the air transmissions of data content, said system comprising:
a content provider center linked with one or more application service providers(ASP), said ASP's sending instructions for data content transfer to said content provider center;
a Push-Pull gateway comprising:
a network inbound queue in said gateway for reception of said instructions related to said data content transfer;
a scheduler for parsing said instructions for directives comprising:
Push and Pull transmissions, and broadcast times and schedule related to said transmissions;
a content fetcher for the extraction of said data content, over a network from one or more content providers, based upon said directives;
a data processor for encoding said extracted data content;
an addressing module for parsing said instructions for extracting addressing instructions,
an outbound queue for broadcast transmission of said encoded data content based upon said parsed addressing instructions and said schedule, and
a broadcast network transmitting said broadcast transmission from said outbound queue to one or more consumer client devices.

42. A datacasting system for scheduling over the air transmissions of data content, as per claim 41, wherein said gateway further comprises a subscription client device profile database, said subscription client device profile database holding profiles associated with said clients, and each of said profiles defining one or more specific data content formats for said transmissions via said outbound queue to one or more consumer client devices.

43. A datacasting system for scheduling over the air transmissions of data content, as per claim 42, wherein said instructions related to data content transfer further comprise a request for identifying said one or more specific data content formats associated with one or more specific clients.

44. A datacasting system for scheduling over the air transmissions of data content, as per claim 41, wherein said gateway further comprises a Push ID/Originator ID extractor for extracting a unique ID associated with a sender of said received instructions, assigning a unique ID associated with said Push transmissions, and storing said Push ID/Originator ID in a Push recorder.

45. A datacasting system for scheduling over the air transmissions of data content, as per claim 44, wherein said gateway further comprises a Push authenticator for authentication of said sender of said received instructions.

46. A datacasting system for scheduling over the air transmissions of data content, as per claim 44, wherein said outbound queue further comprises a network outbound queue and a broadcast outbound queue, said network outbound queue transmitting data content to said sender of said received instructions and said broadcast outbound queue transmitting data content to an external broadcasting network.

47. A datacasting system for scheduling over the air transmissions of data content, as per claim 46, wherein said broadcast network is an in-band on-channel (IBOC) network.

48. A datacasting system for scheduling over the air transmissions of data content, as per claim 41, wherein said gateway further comprises a bandwidth module for bandwidth management, said bandwidth module maintaining queues and prioritizing flows per quality of service (QoS) traffic attributes while keeping resource starvation to a minimum.

49. A datacasting system for scheduling over the air transmissions of data content, as per claim 48, wherein said queues further comprise an active queue and a passive queue, said active queue storing data content currently being transmitted and said passive queue storing pushed and pulled data content.

50. A datacasting system for scheduling over the air transmissions of data content, as per claim 41, wherein said gateway further comprises a cache for holding said data content to be transmitted.

51. A datacasting system for scheduling over the air transmissions of data content, as per claim 41, wherein said instructions related to said data content transfer comprise precompiled binary data for transmission.

52. A datacasting system for scheduling over the air transmissions of data content, as per claim 41, wherein said scheduler further parses for pushed geographic zone information defining various time of day of same geographic zone and different geographic zones for broadcasting said encoded data content.

53. A datacasting system for scheduling over the air transmissions of data content, as per claim 41, wherein said instructions include a unique identifier, said identifier used in targeting said transmitted data content to a specific user agent in receiver direct device.

54. A datacasting system for scheduling over the air transmissions of data content, as per claim 53, wherein said identifier is an URI or a numeric value.

55. A datacasting system for scheduling over the air transmissions of data content, as per claim 41, wherein said data processor further comprises a data transformer and a data encoder, said data transformer converting said extracted data content into a specific format and said data encoder encapsulating said extracted data content in a specific format.

56. A datacasting system for scheduling over the air transmissions of data content, as per claim 55, wherein said encoder is Turbo Broadcast Layer.

57. A datacasting system for scheduling over the air transmissions of data content, as per claim 41, wherein said gateway communicates to external networks via any of the following protocols: point-to-point protocol (PPP), hypertext transfer protocol (HTTP), wireless access protocol, satellite networks, or wireless access protocol.

58. A datacasting system for scheduling over the air transmissions of data content, as per claim 41, wherein said transmitted data content is in one of the following formats: binary, plain text, HTML, XML, or WML.

59. A datacasting system for scheduling over the air transmissions of data content, as per claim 41, wherein said gateway further comprises a timer for tracking a predefined timeout for which transmission of data content occurs.

60. A datacasting system for scheduling over the air transmissions of data content, as per claim 41, wherein said gateway is networked for synchronized scheduling with one or more similar gateways and said transmitted data propagates through said network of gateways before reaching one or more iBOC client devices.

61. A datacasting system for scheduling over the air transmissions of data content, as per claim 41, wherein said parsed directives further include any of the following: time at which transmission is to commence, time at which transmission is to cease, or rate at which data content to be transmitted needs to be repeated.

62. A datacasting system for scheduling over the air transmissions of data content, as per claim 41, wherein said network for said extraction of data content is any of the following: local area network, wide area network, wireless network, HFC networks or Internet.

63. A datacasting system for scheduling over the air transmissions of data content, as per claim 41, wherein said gateway further comprises a network database supplying the content fetcher with locations of remote databases from which information is to be extracted.

64. A datacasting Push-Pull gateway for scheduling over the air transmissions of data content, as per claim 41, wherein said encoded data content is in a digital broadcasting format suitable for reception via a digital consumer radio receiver.
